(19) United States
(12) Patent Application Publication
(10) Pub. No.: US 2019/0143782 A1
(43) Pub. Date: May 16, 2019

(54) AIR MANAGEMENT SYSTEM FOR CARGO SPACE OF A VEHICLE

(71) Applicant: Carrier Corporation, Palm Beach Gardens, FL (US)

(72) Inventor: Harold Hill, Jr., Jamesville, NY (US)

(21) Appl. No.: 16/097,923

(22) PCT Filed: Apr. 20, 2017
(86) PCT No.: PCT/US2017/028528

§ 371 Date: Oct. 31, 2018

Related U.S. Application Data
(60) Provisional application No. 62/331,053, filed on May 3, 2016.

(51) Int. Cl. B60H 1/00; B60H 1/24; B60J 7/12; B60P 3/20; B61D 39/00; F24F 13/02; F24F 13/068

(52) U.S. Cl. CPC B60H 1/00014; B60H 1/00564; B60H 1/245; F24F 13/068; B60P 3/20; B61D 39/00; F24F 13/0218; B60J 7/1256

(57) ABSTRACT

A cargo space air management system for a vehicle includes a body defining one or more cavities therein and one or more ports configured to enable fluid communication through the one or more ports into at least one of the one or more cavities. The body is configured to attach to be placed in a cargo space of the vehicle, and the body is deployable from a first state to a second state, wherein in the second state the body covers a portion of the cargo space and forms an air filled cavity within the body.

### BACKGROUND

The subject matter disclosed herein generally relates to air management for vehicles and, more particularly, to air management systems for vehicles having cargo spaces for use with a cooling unit.

Cooling systems in vehicles may be configured with cooling systems, such as cooling units, that are set up for providing cooling within a cargo space. Some cooling units may be removably installable through opening in walls of the vehicle. These units may be relatively small and manually installable. The cooling units may be configured with blowers or fans that direct air within the cargo space. When using such cooling units, the air may be blown upward within the cargo space toward the roof or ceiling, and the air is then distributed into the cargo space because the ceiling provides a flow surface along which the air may flow. Further, not all vehicles that have cargo space are adequately configured to enable air conditioned cargo space.

### SUMMARY

According to one embodiment, a cargo space air management system for a vehicle is provided. The cargo space air management system includes a body defining one or more cavities therein and one or more ports configured to enable fluid communication through the one or more ports into at least one of the one or more cavities. The body is configured to be placed in a cargo space of the vehicle and the body is deployable from a first state to a second state, wherein in the second state the body covers a portion of the cargo space and forms an air filled cavity within the body.

In addition to one or more of the features described above, or as an alternative, further embodiments of the cargo space air management system may include a housing configured to house the body in the first state, the housing configured to be mounted to a vehicle frame.

In addition to one or more of the features described above, or as an alternative, further embodiments of the cargo space air management system may include one or more support structures configured to support a first end of the body.

In addition to one or more of the features described above, or as an alternative, further embodiments of the cargo space air management system may include a cooling unit installed into a wall of the vehicle.

In addition to one or more of the features described above, or as an alternative, further embodiments of the cargo space air management system may include a duct configured to fluidly connect the cooling unit to at least one of the one or more ports of the body.

In addition to one or more of the features described above, or as an alternative, further embodiments of the cargo space air management system may include at least one fastener configured to fixedly attach the body to a vehicle frame.

In addition to one or more of the features described above, or as an alternative, further embodiments of the cargo space air management system may include a cooling unit attached to the body and configured to attach to a vehicle frame.

In addition to one or more of the features described above, or as an alternative, further embodiments of the cargo space air management system may include at least one additional port located in the body, wherein air may flow through both the one or more ports and the at least one additional port.

In addition to one or more of the features described above, or as an alternative, further embodiments of the cargo space air management system may include that the one or more ports are located at a first end of the body and the at least one additional port is located at a second end of the body.

In addition to one or more of the features described above, or as an alternative, further embodiments of the cargo space air management system may include at least one fan configured to blow air through the one or more cavities within the body.

In addition to one or more of the features described above, or as an alternative, further embodiments of the cargo space air management system may include that the body includes a first layer and a second layer, wherein the first layer is configured between the second layer and the cargo space when installed on a vehicle frame.

According to another embodiment, a method of installing a cargo space air management system onto a vehicle is provided. The method includes positioning the cargo space air management system about a cargo space of the vehicle, attaching the cargo space air management system to the vehicle, and inflating the cargo space air management system to provide air management for the cargo space. The cargo space air management system includes a body defining one or more cavities therein and one or more ports configured to enable fluid communication through the one or more ports into at least one of the one or more cavities and the body is deployable from a first state to a second state, wherein in the second state the body covers the cargo space and forms an air filled cavity above the cargo space.

In addition to one or more of the features described above, or as an alternative, further embodiments of the method may include fluidly connecting a cooling unit to the at least one port.

In addition to one or more of the features described above, or as an alternative, further embodiments of the method may include operating a fan to at least one of pull air into or blow air out of the one or more cavities of the body.

In addition to one or more of the features described above, or as an alternative, further embodiments of the method may include that the cargo space air management system further comprises a housing configured to house the body in the first state, the housing configured to be mounted to a vehicle frame, the method further comprising positioning and mounting the housing to the vehicle frame.

In addition to one or more of the features described above, or as an alternative, further embodiments of the method may include a cooling unit installed into a wall of the vehicle, wherein the cooling unit is configured to inflate the cargo space air management system.

In addition to one or more of the features described above, or as an alternative, further embodiments of the method may include fluidly connecting the cooling unit to the one or more cavities with at least one duct.

In addition to one or more of the features described above, or as an alternative, further embodiments of the method may include fastening the body to a vehicle frame.

In addition to one or more of the features described above, or as an alternative, further embodiments of the method may include operating a cooling unit attached to the body and configured to attach to a vehicle frame to inflate the cargo space air management system.

In addition to one or more of the features described above, or as an alternative, further embodiments of the method may include that the body further comprises at least one additional port located in the body, wherein air may flow through both the one or more ports and the at least one additional port, the method further comprising circulating air through the one or more ports, through the body, and through the at least one additional port.

Technical effects of embodiments of the present disclosure include a cargo space air management system for vehicles to enable air conditioning and/or cooling for cargo spaces that normally cannot provide cooled transport. Further, technical effects include a removable and/or collapsible cargo space air management system that can be moved from one vehicle to another and/or closed up and stowed when not needed.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic view of an exemplary embodiment of a trailer system including a container having a cooling unit and a cargo compartment;

FIG. 1B is a schematic view of an exemplary embodiment of a cooling unit for a cargo compartment of the container of FIG. 1A;

FIG. 2 is a schematic illustration of a vehicle without a tarp cover that may employ various embodiments disclosed herein;

FIG. 3A is a schematic illustration of a vehicle having a cargo space air management system shown separate from the vehicle;

FIG. 3B is a schematic illustration of the vehicle of FIG. 3A with the cargo space air management system installed thereon;

FIG. 3C is a side schematic illustration of the cargo space air management system of FIG. 3A in a deflated state;

FIG. 3D is a side schematic illustration of the cargo space air management system of FIG. 3A in an inflated state;

FIG. 3E is a bottom plan illustration of the cargo space air management system of FIG. 3A;

FIG. 4 is a schematic illustration of a vehicle and cargo space air management system in accordance with another embodiment of the present disclosure;

FIG. 5 is a schematic illustration of a vehicle and cargo space air management system in accordance with another embodiment of the present disclosure;

FIG. 6 is a schematic illustration of a vehicle and cargo space air management system in accordance with another embodiment of the present disclosure;

FIG. 7 is a schematic illustration of a cargo space air management system in accordance with an embodiment of the present disclosure; and

FIG. 8 is a flow process for installing a cargo space air management system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

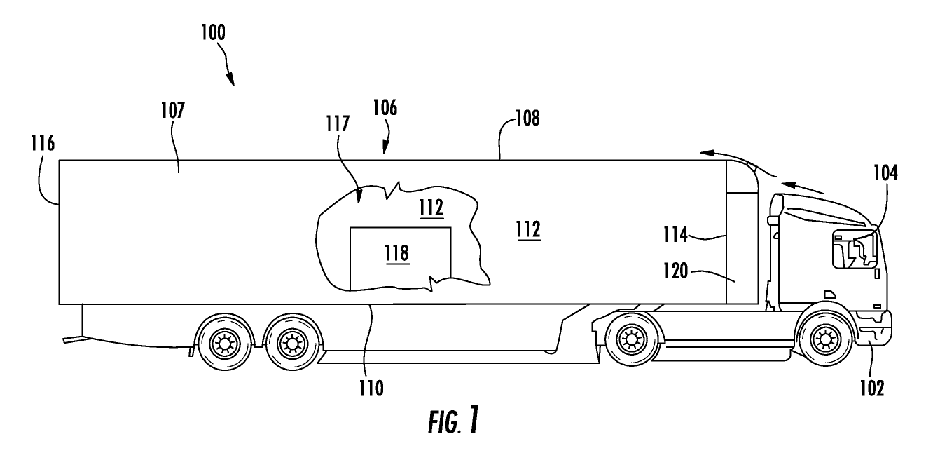

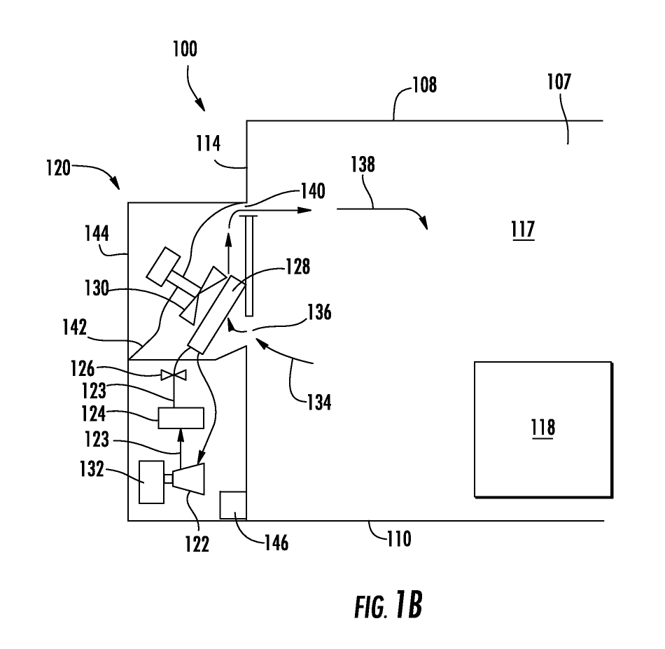

Shown in FIG. 1A is a schematic of an embodiment of a trailer system 100 having a container system 106 as part of a trailer. The trailer system 100 includes a tractor 102 including an operator's compartment or cab 104 and also including an engine, which acts as the drive system of the trailer system 100. A container system 106 is coupled to the tractor 102. The container system 106 is a refrigerated trailer and includes a top wall 108, a directly opposed bottom wall 110, opposed side walls 112, and a front wall 114, with the front wall 114 being closest to the tractor 102, the walls 108, 110, 112, 114 defining a container 107. The container 107 further includes a door or doors (not shown) at a rear wall 116, opposite the front wall 114. The walls of the container 107 define a cargo space 117. The container 107 is configured to maintain a cargo 118 located inside the cargo space at a selected temperature through the use of a cooling unit 120 located on or next to the container 107. The cooling unit 120, as shown in FIG. 1A, is located at or attached to the front wall 114.

Referring now to FIG. 1B, the cooling unit 120 is shown in more detail. The cooling unit 120 includes a compressor 122, a condenser 124, an expansion valve 126, an evaporator 128, and an evaporator fan 130. The compressor 122 is operably connected to a refrigeration engine 132 which drives the compressor 122. The refrigeration engine 132 is connected to the compressor in one of several ways, such as a direct shaft drive, a belt drive, one or more clutches, and/or via an electrical generator. A refrigerant line 123 fluidly connects the components of the cooling unit 120.

Airflow is circulated into and through the cargo space of the container 107 by means of the cooling unit 120. A return airflow 134 flows into the cooling unit 120 from the cargo space of the container 107 through a cooling unit inlet 136, and across the evaporator 128 via the evaporator fan 130, thus cooling the return airflow 134 to a selected or predetermined temperature. The cooled return airflow 134, now referred to as supply airflow 138, is supplied into the cargo space of the container 107 through a cooling unit outlet 140, which in some embodiments is located near the top wall 108 of the container 107. The supply airflow 138 cools the cargo 118 in the cargo space of the container 107. It is to be appreciated that the cooling unit 120 can further be operated in reverse to warm the container 107 when, for example, the outside temperature is very low. Those of skill in the art will appreciate that the airflow indicated in FIG. 1B (e.g., 134, 138) can be reversed without departing from the scope of the present disclosure.

The cooling unit 120 is positioned in a frame 142 and contained in an accessible housing 144, with the frame 142 and/or the housing 144 secured to an exterior side of the front wall 114 such that the cooling unit 120 is positioned between the front wall 114 and the tractor 102, as shown in FIG. 1A.

The cooling unit 120 includes a power connector 146. Power connector 146 may be configured to receive a plug or other wired connection to supply electrical power to the cooling unit 120. When the container system 100 is located at a port, loaded on a ship, attached to a tractor, etc., a power supply (not shown) may be connected to the power connector 146. When the container 107 is moved from one location to another, the power connector 146 may be required to be disconnected from a power source such that the container 107 is not physically connected to or wired to a power source, enabling freedom of movement of the container 107. In some embodiments the power source include, but is not limited to, grid power, engine supplied power, auxiliary power unit power, etc.

When the power connector 146 is disconnected from a power source, the cooling unit 120 may not be able to be operated to continuously supply conditioned air within the cargo space of the container 107. If the power supply is absent for too long of a period, the temperature within the cargo space of the container 107 may change sufficiently to become detrimental to any cargo within the cargo space. For example, if the cooling unit 120 is not operated within a predetermined time period, the air temperature within the cargo space of the container 107 may rise to levels that are above desired temperatures for a specific cargo within the container 107.

It will be appreciated by those of skill in the art that the systems and configurations of FIGS. 1A and 1B are merely exemplary and provided for illustrative and descriptive purposes only. The disclosure is not limited thereby. For example, although a tractor-trailer configuration is shown, systems may be employed in other container configurations, in various truck configurations, and/or in other systems and configurations. Further, as will be appreciated by those of skill in the art, the container and cargo space may be configured as a sea container, and thus may be configured to stack with other containers and be shipped on a shipping vessel.

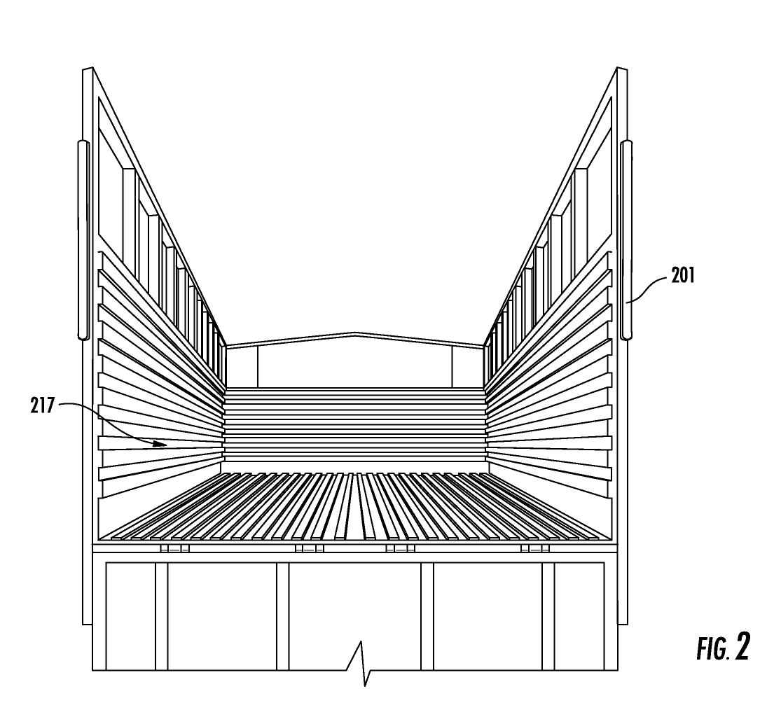

FIG. 2 is a schematic illustration of a vehicle 201 having an open bed or cargo space 217, such as a tarp-covered truck. The vehicle 201 cannot employ a fixed or rigid cooling unit because any cooling would be lost due to the open air of the cargo space 217. Even when a cover, such as a tarp, is configured over the cargo space 217, the leakage of any cooling would be sufficient to negate the cooling. However, using a semi-rigid cover (or even a tarp) a cooling unit can be mounted on the vehicle 201 to provide cooling to the cargo space.

However, when a cooling unit is installed in the front wall of a vehicle 201, the evaporator air flow is not ducted properly near the ceiling of the cargo area 217. Such lack of ducting can lead to poor air throw and thus poor and/or ineffective cooling in the cargo space. Accordingly, it may be advantageous to have a cooling unit that is able to be installed in a vehicle (e.g., vehicle 201) that provides improves air throw and cooling flow and distribution within the cargo space 217.

For example, embodiments disclosed herein provide a removable, cargo space air management system for a truck or truck rack that defines a volume that is in fluid communication with a cooling unit. The cargo space air management system is configured to provide air channels that take heat away from the radiated heat of the sun and/or the heat of respiration of a cargo in a cargo space or personnel within the cargo space. In some embodiments, a number of channels or cavities are configured within the cargo space air management system to provide air flow, distribution, and insulation. The cargo space air management system can be designed to be openable for loading and/or empty transport purposes or, in some embodiments, permanently fixed and mounted to a truck or truck rack.

Cargo space air management systems in accordance with embodiments of the present disclosure are configured to take unwanted heat away from and/or provide cooling to the entire cargo space of a vehicle. According to some embodiments, the cargo space air management system is configured to stow away for loading or empty transport purposes. Advantageously, embodiments provided herein can augment the effectiveness of cooling units for vehicles by evenly distributing air to reduce the amount of heat that causes spoilage during transportation.

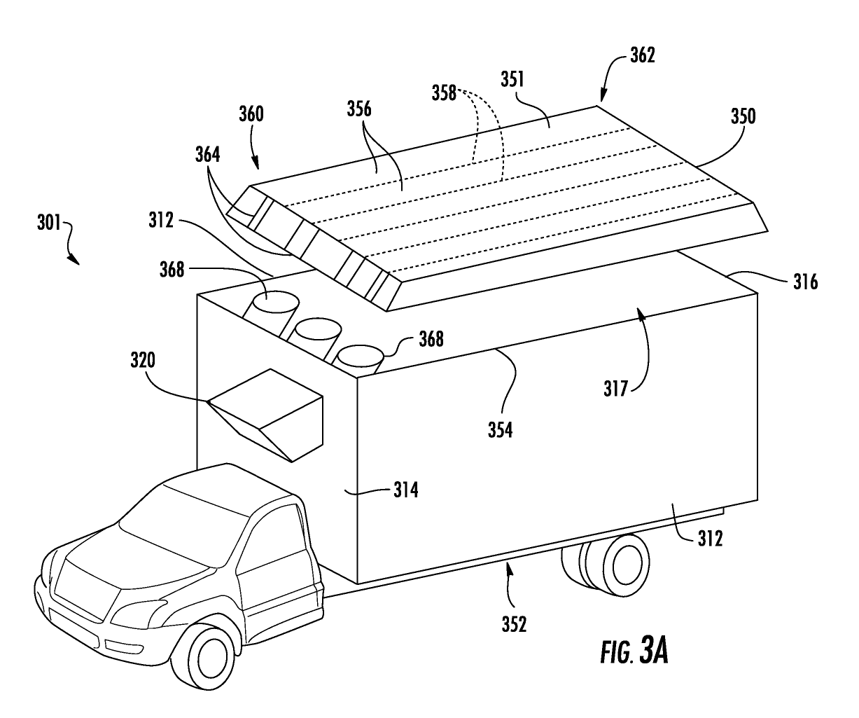

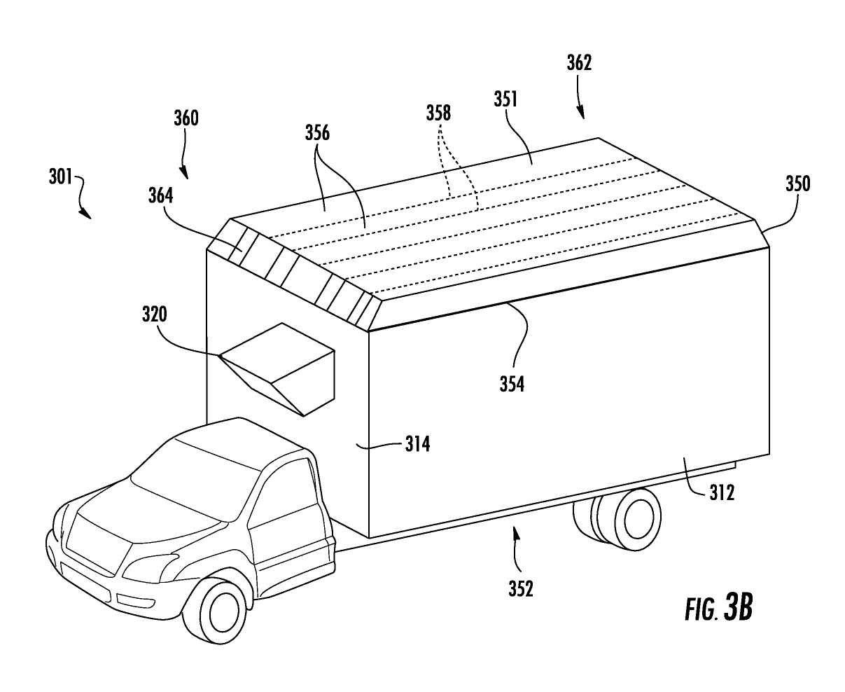

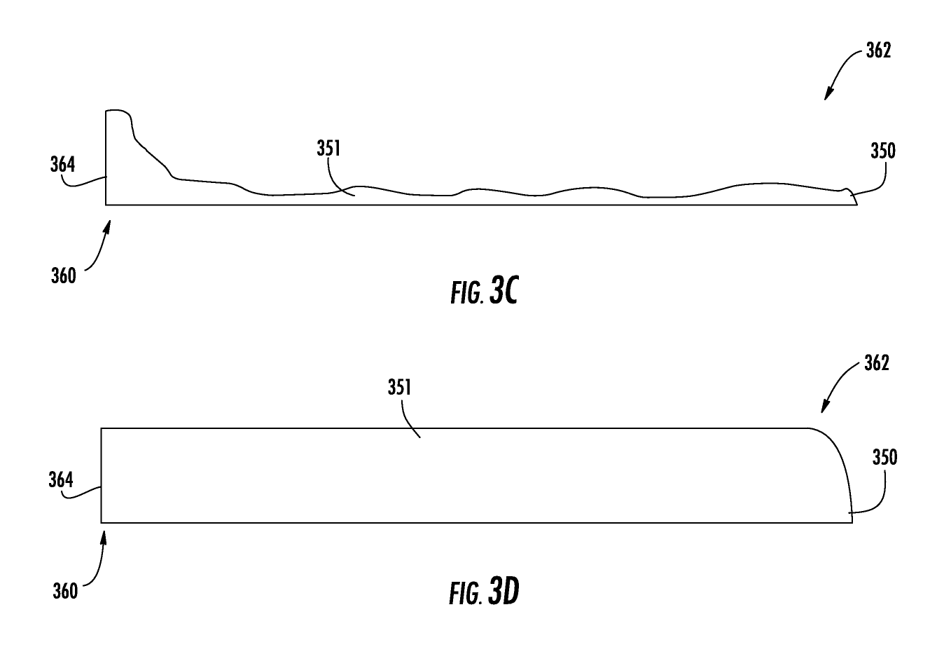

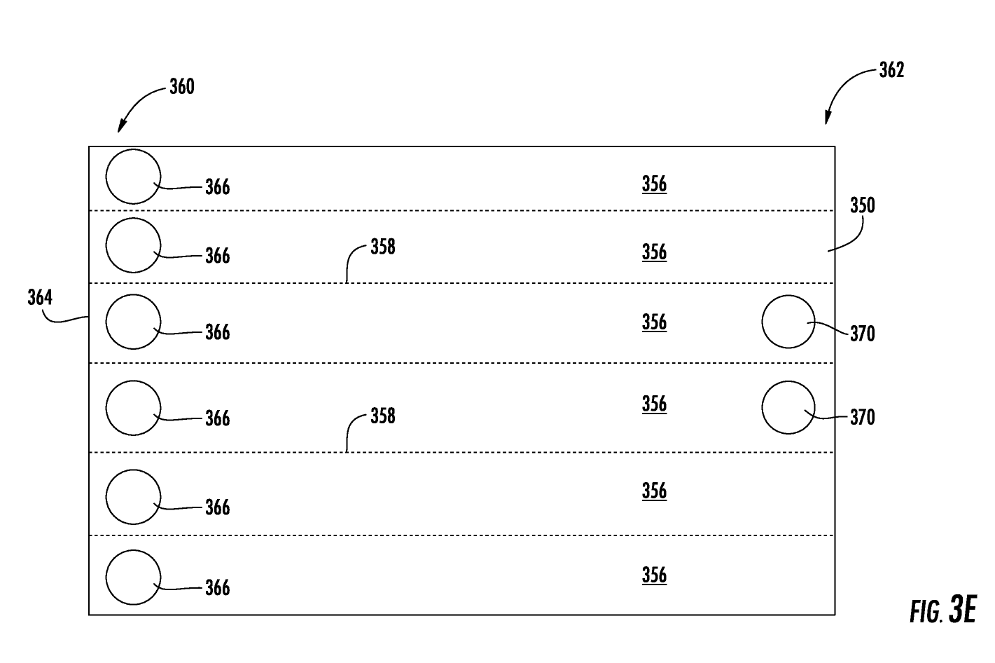

Turning to FIGS. 3A-3E, schematic illustrations of a cargo space air management system 350 in accordance with an embodiment of the present disclosure are shown. FIG. 3A shows the cargo space air management system 350 above and separated from a vehicle 301. FIG. 3B shows the cargo space air management system 350 as installed and inflated on the vehicle. FIG. 3C is a side-view schematic of the cargo space air management system 350 in a deflated state. FIG. 3D is a side-view schematic of the cargo space air management system 350 in an inflated state. FIG. 3E is a bottom plan view of the cargo space air management system 350.

The vehicle 301 is a truck or other vehicle having a cargo system 352, such as an open-top trailer or bed. As shown, the vehicle 301 has a cooling unit 320 installed in a front wall 314. The cooling unit 320 is configured to supply cool air into a cargo space 317. The cooling unit 320 may include various features and components as described above, including, but not limited to, a condenser and an evaporator. In the cooling unit 320 of FIG. 3, the condenser can be configured outside of the cargo space 317 and the evaporator can be configured within the cargo space 317.

As shown, the cargo space air management system 350 is positioned above the cargo space 317 (shown schematically separated from the vehicle 301). In this configuration, the cargo space 317 is defined by the front wall 314, side walls 312, and an optional rear wall 316 (e.g., the rear wall 316 may be a frame, doors, or not present at all) and is open at the top. The tops of the walls 312, 314, 316 can define a top frame 354. The cargo space air management system 350 can be mounted to and/or attached to the top frame 354 (e.g. as shown in FIG. 3B). However, in other embodiments, one or more cargo space air management systems can be installed on sidewalls, rear walls, front walls, floors of the cargo space, etc. Accordingly, although shown attached above a cargo space as a top cover, those of skill in the art will appreciate that embodiments provided here can be installed in various other configurations without departing from the scope of the present disclosure. Further, in some embodiments, the cargo space air management system can be configured to be attached to and/or install directly to or about one or more items of cargo within a cargo space of a vehicle (e.g., applied directly to the cargo rather than the entire cargo space).

A body 351 of the cargo space air management system 350, in some embodiments, is formed from fabrics, plastics, rubbers, polymers, etc. The body 351 defines one or more cavities or channels 356 therein. The cavities 356 may be fluidly separated from each other by dividers 358. The dividers 358 may be pleats or other sections or walls that are within the interior of the cargo space air management system 350. In some embodiments, the dividers 358 may be formed by stitching, sewing, or other similar structures. The cavities 356, in the embodiment shown in FIGS. 3A-3E, extend from a first end 360 to a second end 362 of the cargo space air management system 350. The first end 360 may include one or more support structures 364 that provide structural support to the first end 360 (e.g., as shown in FIG. 3C).

As shown in FIGS. 3C-3D, side schematic illustrations of the cargo space air management system 350 are shown. FIG. 3C shows the cargo space air management system 350 in a deflated state and FIG. 3D shows the cargo space air management system 350 in an inflated state. As shown in FIG. 3C, the first end 360 remains upright relative to the rest of the cargo space air management system 350 due to the one or more support structures 364. The support structures 364 may be a frame structure. When the cargo space air management system 350 is installed onto the vehicle 301 having the cooling unit 320, the cavities 356 of the cargo space air management system 350 can be fluidly connected to the cooling unit 320. When the cooling unit 320 is activated, cool air can be directed into the cavities 356 of the cargo space air management system 350, thus inflating the cargo space air management system 350.

As shown in FIG. 3E, the cargo space air management system 350 can include one or more first ports 366 at the first end 360. The first ports 366 can be fluidly connected to ducting 368 (shown in FIG. 3A) that can directly connect the cooling unit 320 to the cargo space air management system 350. As the air enters the cavities 356, the cargo space air management system 350 inflates, thus providing a volume of air that can provide insulation to the cargo space 317. In some embodiments, inflation of the cargo space air management system can include inflation using a pressure hose (e.g., from gas station, from air compressor on vehicle (air brakes), etc.). In some embodiments, the cargo space air management system can be connected to an air brake system of a vehicle during operation to maintain a desired (e.g., constant) pressure within the cargo space air management system. Further, in some embodiments, solar energy could be employed to heat up a medium that is part of the cargo space air management system that pulls on the body and expands the body to form the interior channels or cavities.

In some embodiments, the cargo space air management system 350 may include one or more second ports 370 at the second end 362 of the cargo space air management system 350. The second ports 370 can be provided to enable cool air within the cargo space air management system 350 (from the cooling unit 320) to flow downward at the second end 362 and into the cargo space 317.

In some embodiments, a reverse flow is possible. That is, a condenser coil can be cooled by air that is pulled from the rear of the vehicle 301. Accordingly, the air within the cargo space 317 can be used to aid in further cooling within the cargo space air management system 350. For example, air pulled through the cargo space air management system 350 from the rear of the vehicle 301 to the cooling unit 320 can provide cooling within the cargo space air management system 350 and thus aid in cooling the cargo space 317.

In alternative configurations, the cargo space air management system 350 may not be directly, fluidly connected to the cooling unit 320. In such embodiments, the cargo space air management system 350 may be installed on the top frame 354 in a deflated state (e.g., FIG. 3C). Then, as the cargo space 317 heats up (e.g., through heat from the sun, respiration, etc.) the warm air may rise and flow through the ports 366, 370 into the cavities 356, thus forming an air cushion and/or insulation that prevents further heating of the cargo space 317.

Because the cargo space air management system 350 may be relatively flexible (e.g., formed from a fabric or other material), the cargo space air management system 350 can be folded or rolled up for storage and/or transportation. In some embodiments, the only rigid component of the cargo space air management system 350 may be the supports 364.

The cargo space air management system 350 can be attached to the top frame 354 by various mechanisms. For example, in some embodiments, the cargo space air management system 350 may include eyelets or other features that enable the cargo space air management system 350 to be tied to the top frame 354. Other fasteners may be used including, but not limited to, screws, nails, hook-and-loop material, zippers, etc. without departing from the scope of the present disclosure.

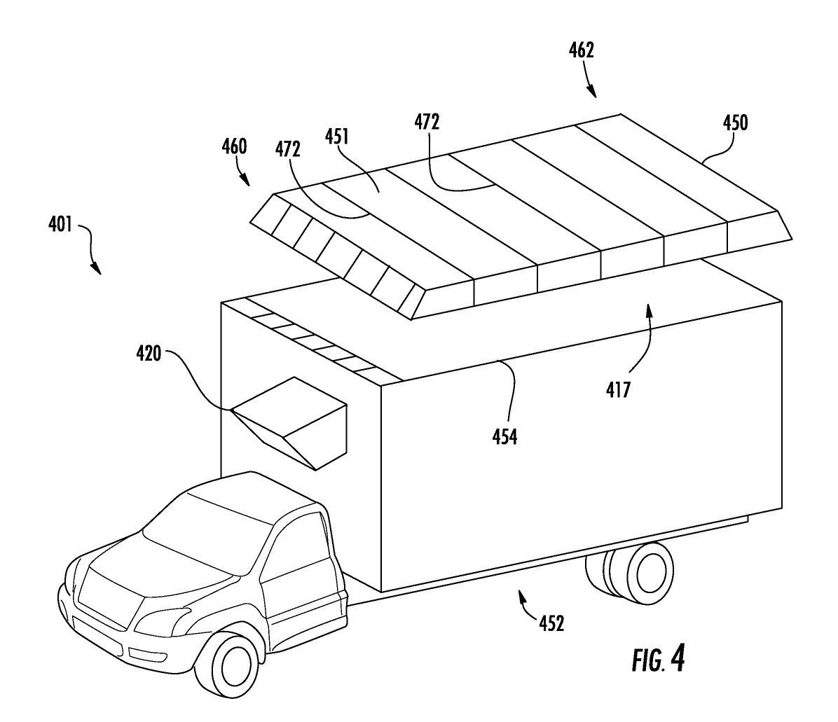

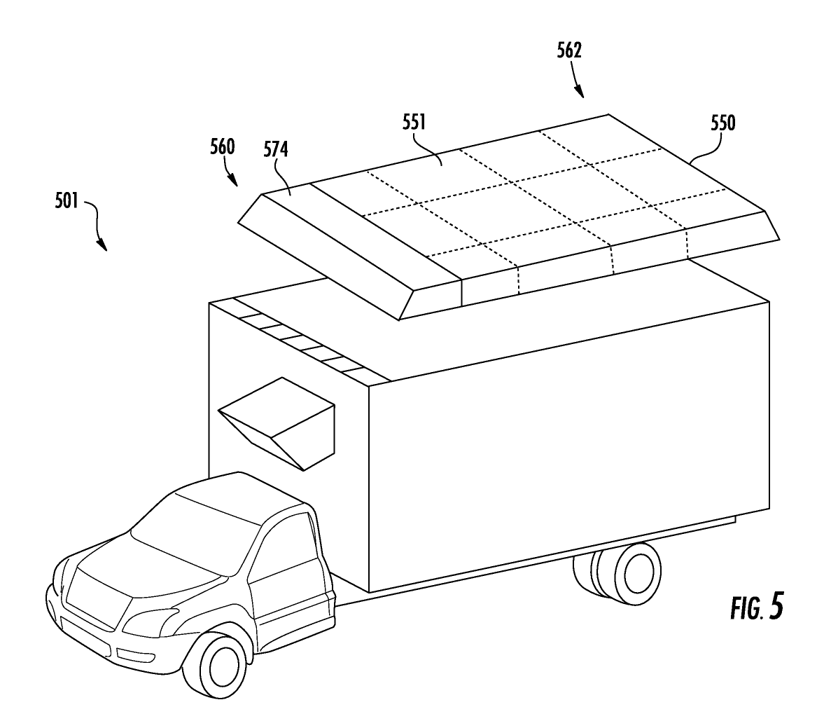

Turning now to FIG. 4, an alternative configuration in accordance with an embodiment of the present disclosure is shown. In FIG. 4, a vehicle 401 having a cooling unit 420 is configured to have a cargo space air management system 450 installed on a top frame 454 of the vehicle 401. The cargo space air management system 450 can be used to cover a cargo space 417 of the vehicle 401. Similar to the above described embodiment, a body 451 of the cargo space air management system 450 can include one or more cavities within an interior space of the body 451. However, the primary difference between the cargo space air management system 450 of FIG. 4 and the embodiment of FIGS. 3A-3E is that the body 451 has a hard-shell structure. That is, the cargo space air management system 450 is formed of a hard plastic, metal, etc. and is attached to the top frame 454 of the vehicle 401.

Similar to the above described embodiments, the cargo space air management system 450 of FIG. 4 is removable and stowable. For example, the cargo space air management system 450 includes joints 472 at various locations along the length of the body 451 of the cargo space air management system 450 from the first end 460 to the second end 462. The joints 472 are configured to enable the cargo space air management system 450 to be folded in an accordion-like manner. As such, even when a cargo space air management system in accordance with the present disclosure is formed from a hard-shell material, it may be collapsible.

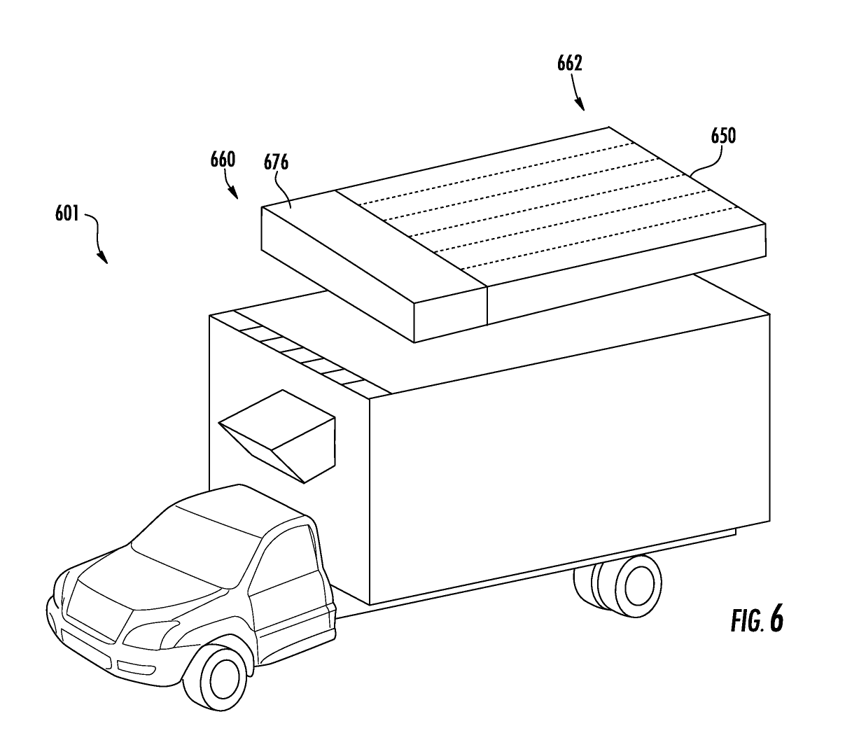

Turning now to FIG. 5, another alternative configuration in accordance with embodiments of the present disclosure is shown. In FIG. 5, the vehicle 501 is shown with a cargo space air management system 550 that is telescoping. That is, the cargo space air management system 550 may include a housing 574 that houses a body 551 of the cargo space air management system 550 in a stowed state, and then the body 551 can telescope and extend from the housing 574 from the first end 560 toward the second end 562. In such embodiments, the housing 574 may mount to the vehicle 501 and then after deployment, the body 551 may also be mounted to the vehicle 501. Similar to that described above, the body 551 may define one or more cavities therein.

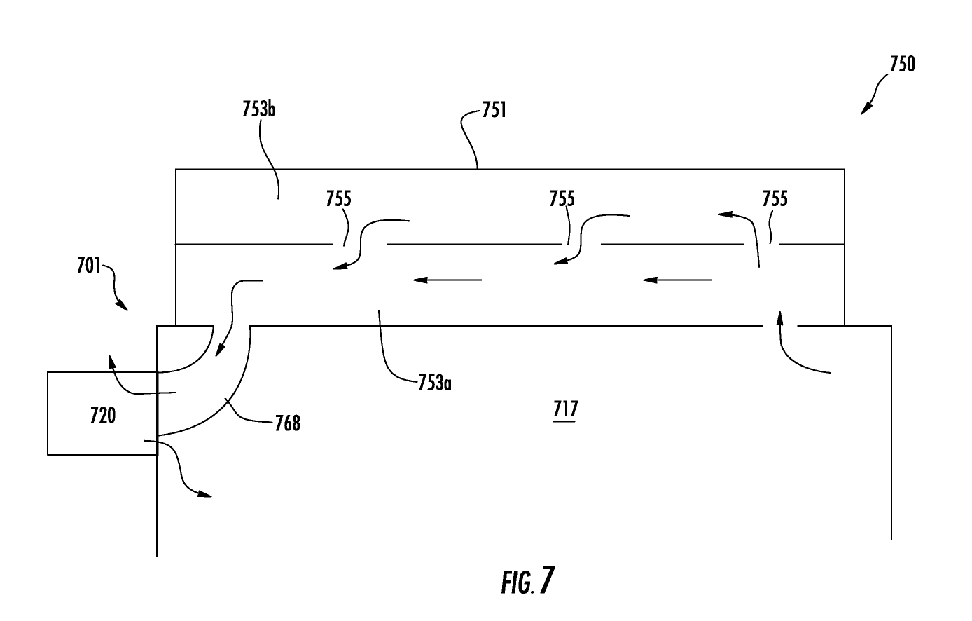

Turning now to FIG. 6 another alternative configuration in accordance with embodiments of the present disclosure is shown. In FIG. 6, the vehicle 601 has a cargo space air management system 650 shown above a cargo space, similar to that shown and described above. The primary difference between the embodiment of FIG. 6 and the embodiments shown and described above is that the cargo space air management system 650 includes an integrated cooling unit 676. The integrated cooling unit 676 may include similar features and components as the cooling units described above, including, but not limited to, an evaporator, a condenser, and one or more fans. The fans of the integrated cooling unit 676 may be configured to blow cool air through the cavities of the cargo space air management system 650. As shown, the integrated cooling unit 676 is located at a first end 660 of the cargo space air management system 650, although in other embodiments the integrated cooling unit 676 can be located at the second end 662 (or even in the middle of the cargo space air management system 650). In some embodiments, the integrated cooling unit 676 may be a fan system that does not include cooling elements, but is only configured to force air into and/or out of the cavities of the cargo space air management system 650.

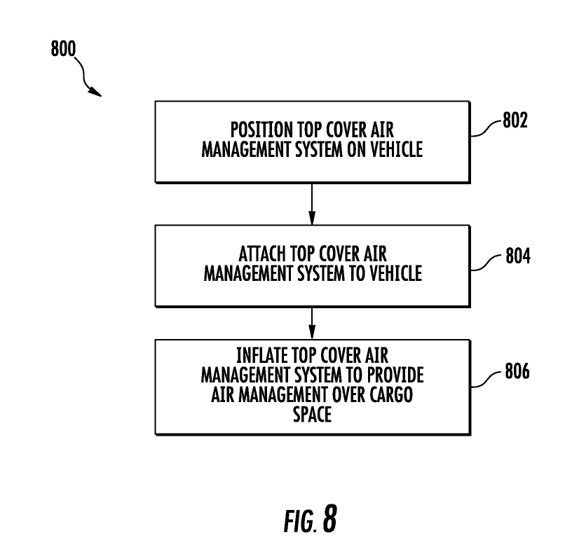

Turning now to FIG. 7, another embodiment of a cargo space air management system in accordance with the present disclosure is shown. In the embodiment shown in FIG. 7, a cargo space air management system 750 has a body 751 that includes a first layer 753a and a second layer 753b. As shown, the second layer 753b is stacked on top of or above the first layer 753a. Each layer 753a, 753b can have one or more cavities or channels (as described above). The cargo space air management system 750 is installed on top of a vehicle 701 having a cooling unit 720 that is used to cool a cargo space 717.

FIG. 7 shows an example airflow through the cargo space air management system 750 as indicated by the arrows. As shown, the airflow flows from the rear of the vehicle 701 toward the front, where the cooling unit 720 is located. Further, as shown, air from the cargo space air management system 750 is connected to the cooling unit 720 by optional ducting 768 (e.g., as described above). In the embodiment of FIG. 7, the airflow pulled through the cargo space air management system 750 is used for cooling a condenser coil within the cooling unit 720 and then is exhausted, as indicated by the arrows.

As noted, the body 751 of the cargo space air management system 750 includes a first layer 753a and a second layer 753b. The first layer 753a can be used to provide a relatively cool layer above the cargo space 717. Further, the second layer 753b can be used to provide a relatively warmer insulating layer that insulates the cargo space 717 (and the first layer 753a) from thermal energy from the exterior (e.g., solar radiation). As shown, the first layer 753a is fluidly connected to the cargo space 717 (as described above) and is also fluidly connected to the second layer 753b by one or more apertures 755. If one or both of the layers 753a, 753b is separated into separate cavities and/or channels, some or all of the cavities and/or channels may be fluidly connected between layers or may be fluidly isolated or separate from other the other layer. The apertures 755 are optional, and in some embodiments, the first layer 753a may be fluidly isolated from the second layer 753b, or in other embodiments, one-way valves or flaps can be configured to enable one-way flow from one layer to another.

Turning now to FIG. 8, a flow process for installing and using a cooling unit and cargo space air management system in a vehicle in accordance with an embodiment of the present disclosure is shown. The cargo space air management system may be similar to any of the above described non-limiting embodiments, or variations thereon.

At block 802, the cargo space air management system is positioned on the vehicle. The positioning may depend on the specific configuration of the cargo space air management system. For example, if the cargo space air management system is similar to the embodiments of FIGS. 3A-4, the ends of the cargo space air management system may be positioned about the front and rear portions of the structure of the vehicle defining a cargo space. This may include extending the cargo space air management system from a stowed state into an extended or deployed stated. For example, if the cargo space air management system is similar to that shown in FIG. 4, the accordion-style cargo space air management system can be extended to the shape and size to cover the top of the cargo space. If the cargo space air management system is similar to the embodiment shown in FIG. 5, the housing of the cargo space air management system can be positioned on the vehicle and then the body of the cargo space air management system can be extended or deployed to cover the cargo space of the vehicle.

At block 804, the cargo space air management system is attached to the vehicle. In some embodiments, this may include using ties or other fasteners to physically connect the cargo space air management system to the vehicle.

At block 806, the cargo space air management system can be inflated to provide an air cushion or insulation atop the vehicle. The inflation may be achieved by operation of a cooling unit that is part of the vehicle, installed into the vehicle (e.g., FIGS. 3A-5), and/or part of the cargo space air management system (e.g., FIG. 6). Alternatively, the inflation may be achieved passively through thermal expansion of air within the body of the cargo space air management system. Solar energy may heat the air within the cargo space air management system and thus the body may inflate and form a thermal barrier and insulting volume to prevent excessive heating of the cargo space. The cargo space air management system may also operate to circulate and/or direct cooled air within the cargo space.

When uninstalling the cargo space air management system, the opposite of flow process 800 can be performed. For example, the cargo space air management system can be deflated (e.g., by disabling a cooling unit and/or letting the cargo space air management system naturally cool). The cargo space air management system can then be detached from the vehicle, and then completely removed. Thus, the cargo space air management system can be transferred and installed on a different vehicle, or removed when not required by cargo (or lack thereof) in the cargo space of the vehicle.

Advantageously, embodiments described herein provide cargo space air management systems configured take unwanted heat away and/or provide cooling air and/or distribution over an entire cargo space of a vehicle that is not normally enclosed. Further, advantageously, according to some embodiments, cargo space air management systems provided herein may be stowed away for loading or empty transport purposes. Moreover, advantageously, cargo space air management systems as provided herein may augment the effectiveness of cooling units by evenly distributing air to reduce the amount of heat that causes spoilage during transportation.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although described herein with respect to trucks, those of skill in the art will appreciate that cooling units as described herein may be employed in other vehicles, such as boats and/or aircraft. Moreover, the cargo space air management system described herein may be able to be completely removed from a vehicle, such that cooling may be provided to a cargo that is removed from the vehicle. That is, the cargo space air management system may be removed from the vehicle and may be moved with a cargo to continuously provide cooling to the cargo.

Further, for example, although various sizes, shapes, etc. are shown in the accompanying drawings, those of skill in the art will appreciate that cargo space air management systems described herein may be scalable, such that smaller or larger units may be made without departing from the scope of the disclosure. Thus, the drawings are merely provided for illustrative and explanatory purposes and are not intended to be limiting.

Accordingly, the present disclosure is not to be seen as limited by the foregoing description, but is only limited by the scope of the appended claims.

What is claimed is:

1. A cargo space air management system for a vehicle comprising:
a body defining one or more cavities therein and one or more ports configured to enable fluid communication through the one or more ports into at least one of the one or more cavities, wherein:
the body is configured to be placed in a cargo space of the vehicle, and
the body is deployable from a first state to a second state, wherein in the second state the body covers a portion of the cargo space and forms an air filled cavity within the body.

2. The cargo space air management system of claim 1, further comprising a housing configured to house the body in the first state, the housing configured to be mounted to a vehicle frame.

3. The cargo space air management system of claim 1, further comprising one or more support structures configured to support a first end of the body.

4. The cargo space air management system of claim 1, further comprising a cooling unit installed into a wall of the vehicle.

5. The cargo space air management system of claim 4, further comprising a duct configured to fluidly connect the cooling unit to at least one of the one or more ports of the body.

6. The cargo space air management system of claim 1, further comprising at least one fastener configured to fixedly attach the body to a vehicle frame.

7. The cargo space air management system of claim 1, further comprising a cooling unit attached to the body and configured to attach to a vehicle frame.

8. The cargo space air management system of claim 1, further comprising at least one additional port located in the body, wherein air may flow through both the one or more ports and the at least one additional port.

9. The cargo space air management system of claim 8, wherein the one or more ports are located at a first end of the body and the at least one additional port is located at a second end of the body.

10. The cargo space air management system of claim 1, further comprising at least one fan configured to blow air through the one or more cavities within the body.

11. The cargo space air management system of claim 1, wherein the body includes a first layer and a second layer, wherein the first layer is configured between the second layer and the cargo space when installed on a vehicle frame.

12. A method of installing a cargo space air management system onto a vehicle, the method comprising:
positioning the cargo space air management system about a cargo space of a vehicle;
attaching the cargo space air management system to the vehicle; and
inflating the cargo space air management system to provide air management for the cargo space,
wherein the cargo space air management system includes a body defining one or more cavities therein and one or more ports configured to enable fluid communication through the one or more ports into at least one of the one or more cavities and the body is deployable from a first state to a second state, wherein in the second state the body covers the cargo space and forms an air filled cavity above the cargo space.

13. The method of claim 12, further comprising fluidly connecting a cooling unit to the at least one port.

14. The method of claim 12, further comprising operating a fan to at least one of pull air into or blow air out of the one or more cavities of the body.

15. The method of claim 12, the cargo space air management system further comprising a housing configured to house the body in the first state, the housing configured to be mounted to a vehicle frame, the method further comprising positioning and mounting the housing to the vehicle frame.

16. The method of claim 12, further comprising a cooling unit installed into a wall of the vehicle, wherein the cooling unit is configured to inflate the cargo space air management system.

17. The method of claim 16, further comprising fluidly connecting the cooling unit to the one or more cavities with at least one duct.

18. The method of claim 12, further comprising fastening the body to a vehicle frame.

19. The method of claim 12, further comprising operating a cooling unit attached to the body and configured to attach to a vehicle frame to inflate the cargo space air management system.

20. The method of claim 12, the body further comprising at least one additional port located in the body, wherein air may flow through both the one or more ports and the at least one additional port, the method further comprising circulating air through the one or more ports, through the body, and through the at least one additional port.
